(19) United States
(12) Patent Application Publication
(10) Pub. No.: US 2004/0235692 A1
(43) Pub. Date: Nov. 25, 2004

(54) Emulsion to preserve keen edge of a blade

(76) Inventor: Ariel Sergio Pfeffer Slobodinsky, Sao Paulo (BR)

Correspondence Address: WINSTON & STRAWN, PATENT DEPARTMENT, 1400 L STREET, N.W., WASHINGTON, DC, 20005-3502, US

(21) Appl. No.: 10/444,739

(22) Filed: May 23, 2003

(51) Int. Cl. C11D 1/00

(52) U.S. Cl. 510/130

(57) ABSTRACT

A method and emulsion for preserving the sharp edge of a metal blade, such as a shaving blade. The method comprises the step of immersing the blade in the emulsion of the invention, and leaving it immersed for the time in-between use of the blade. The emulsion comprises soap base, sodium sulphate lauryl ether, cetostearylic alcohol, ammonium trimethyl cethyl chlorate, anhydrous lanolin, liquid glycerine, aloe vera glycolic extract, propolis glycolic extract, propylene glycol, methyl parabene, propyl parabene, hydrolyzed wheat oil, hydrolyzed soya oil, triethanolamine, fragrance, coloring agent and non-mineralized deionized water.

### FIELD OF INVENTION

The present invention relates to an emulsion for treating blades, and more particularly to an emulsion for preserving the cutting edge effect of shaving or similar blades, by maintaining the blade's optimum function conditions. The invention also relates to a method for preserving the cutting-edge effect of the blades, thereby prolonging the life of the blade.

### BACKGROUND OF INVENTION

Blades which are used for shaving and depilating hair are typically comprised of stainless steel. Generally the stainless steel used for the manufacture of such blades is martensitic steel, or magnetic steel blades. Martensitic steel and magnetic steel blades are low chromium and high carbon grade, compared to ferritic steel. Martensitic stainless steel such as “AISI 420,” is widely used for the manufacture of shaving and depilating blades since it provides high hardness after being tempered, strongly resists abrasion, and cleans easily.

Regardless of the type of steel used for manufacturing such blades, the cutting edge of the blade dulls after each use. As a consequence, a clean-cut shave requires use of a new blade after every couple of uses, or requires used blades to be sharpened after every couple of uses.

Sharpening, stoning, and polishing blades are carried out by high-precision, cylindrical grinders with metric systems. Generally, both sides of the blade is sharpened with a 15° gradient. During the sharpening process, the blade is cooled and lubricated with a vaseline-based solution, a phosphate product, trichlorethylene, zinc salts and polytetrafluorethylene. Thus, the sharpening process is time consuming and is impractical for the typical shaving blade user.

Shaving and depilating blades are customarily made of 0.05-mm thick stripes of AISI 420 martensitic stainless steel. The cutting edge of the blade is about 0.0006 mm. As known in the art, AISI 420 possesses “shape memory” or undergoes “martensitic transformation,” by heating or by immersing the blade into slightly basic solutions. The shape memory effect, or the martensitic transformation, is induced by the cubic phase from the centered phase to the hexagonal compact phase.

As also is known in the art, nickel-titanium alloys have “shape memory” characteristics, and are widely used in the manufacture of endodontics. Thus, when these materials are sterilized under high temperatures, the sharp edges of the materials are maintained.

Thus, a need exists for a method and product for maintaining the sharp cutting edge of shaving blades without the need for stoning, sharpening and polishing by impractical means. Advantageously, the emulsion of the invention provides users of shaving and depilating blades with a product and method that preserves the cutting edge of the blade, without requiring the impractical sharpening processes currently known in the art.

### SUMMARY OF INVENTION

It has been surprisingly found that it is possible to preserve the cutting effect of shaving blades or other similar blades by immersing the blades in a novel lubricating emulsion. The novel method and formulation of the invention takes advantage of the steel blade's shape memory to maintain the blade's sharp cutting edge. Thus, it is possible to prolong the life of the blade for multiple reuse. One advantage of the invention is cost efficiency since the blade user will not need to purchase new shaving blades after a couple of uses.

The emulsion for preservation of a blade edge comprises a blade edge preservation compound of a water-soluble salt of an ether compound or a chlorate compound in an amount sufficient to maintain chromium oxide portions of a blade edge, a hydrophobic substance in an amount sufficient to reduce water contact with the blade's edge, and an alcohol in an amount sufficient to assist in solubilizing the hydrophobic substance, wherein immersion of the blade's edge in the emulsion preserves hardness to facilitate longer service of the blade in shaving.

For purpose of example and not limitation, the blade edge preservation compound is selected from the group consisting of sodium sulphate lauryl ether, and ammonium trimethyl cethyl chlorate or a combination thereof, the hydrophobic substance is selected from the group consisting of: soap base, anhydrous lanolin, and liquid glycerin, or any combination thereof, and the alcohol is selected from the group consisting of: triethanolamine, and cetostearylic alcohol, or a combination thereof.

In one embodiment, the emulsion comprises soap base in an amount between about 5-15%, sodium sulphate lauryl ether in an amount between about 3 to 7%; cetostearylic alcohol in an amount between about 2 to 4%; ammonium trimethyl cethyl chlorate is present in an amount between about 2 to 4%; anhydrous lanolin is present in an amount between about 3 to 7%; liquid glycerin in an amount between about 3 to 7%; and triethanolamine in an amount between about 0.5 to 1.5.

The emulsion may also contain additives such as aloe vera glycolic extract; propolis glycolic extract; propylene glycol; methyl parabene; hydrolyzed wheat oil; hydrolyzed soya oil; fragrance; and coloring agent, or any combination thereof.

Also in accordance of the invention is a method for preserving the cutting edge of a blade, the method comprising the steps of: preparing the emulsion, wherein the emulsion comprises a blade edge preservation compound of a water-soluble salt of an ether compound or a chlorate compound in an amount sufficient to maintain chromium oxide portions of a blade edge; a hydrophobic substance in an amount sufficient to reduce water contact with the blade's edge; and an alcohol in an amount sufficient to assist in solubilizing the hydrophobic substance, wherein immersion of the blade's edge in the emulsion preserves hardness to facilitate longer service of the blade in shaving. The components of the emulsion are mixed and homogenized, and allowed to seet for about 24 to 32 hours.

After the mixture has set for 24 to 32 hours, the mixture is ready for preserving the cutting edge of a blade. The blade is immersed in the mixture and maintained therein a sufficient time to preserve the chromium oxide on the blade edge.

### DETAILED DESCRIPTION OF THE PREFERRED EMBODIMENTS

The cutting edge of the blade is preserved by immersing the blade after each use in the emulsion of the invention. The emulsion comprises components which maintain the protective chromium oxide deposited on the cutting edge of blades during manufacture. While the blade is immersed in the emulsion, it does not contact oxygen and humidity in the air. Therefore, the onset of rust micro-spots which gradually destruct the chromium oxide of the blade, and which is responsible for dulling the blade's keen edge is avoided. By preserving the chromium oxide covering on the edge of the blade, the fast wear-and-tear of the blade's cutting edge after its use is avoided. The emulsion also maintains the blade at a stable pH level during a longer lasting period.

In accordance with the invention, the emulsion comprises a blade edge preservation compound. The blade edge preservation compound comprises soap base, an alkali salt of a fatty ether such as sodium sulfate lauryl ether, an alcohol such as cetostearylic alcohol, an alkyl chlorate, such as ammonium trimethyl cethyl chlorate, hydrophobic agents, such as anhydrous lanolin, and liquid glycerin. The emulsion may further comprise cosmetic agents such as, aloe vera glycolic extract, propolis glycolic extract, propylene glycol, one or more parabenes, such as methylparabene, propylparabene, hydrolyzed wheat oil, hydrolyzed soya oil, triethanolamine, fragrance, color, non-mineralized and deionized water.

The components of the emulsion are mixed and homogenized. Once homogenized, the mix is put aside for 24 to 32 hours. After which, the mix is ready for immersion of the shaving and depilating blades.

After first using the shaving or depilating blade, it is rinsed under tap water. Then, the blade is immersed in the emulsion of the invention after each use and until its next use. The longer the duration of the immersion of the blade, the more effective the results. A longer “sit” time in the emulsion imparts better lubrication of the blade, more-thorough cleaning, and greater impermeability to oxygen attack. That is, the emulsion prevents oxygenation of the metal of the blade by conserving the chromium oxide layer. One advantage from the more-thorough cleaning of the blade is the less likelihood that a user will become irritated from use of the blade.

Before reusing the blade, it is rinsed under water. This cycle of rinsing the blade, using the blade for shaving, rinsing the blade, immersing the blade in emulsion during its non-use, is repeated allowing a considerable prolonging of the life of the shaving blade, which may reach about 200 shaving or depilating actions.

The aloe vera and propolis glycolic components of the formulation are within a hydrophobic and oily medium and remain on the blade after it is removed from the emulsion, and rinsed with water before its use.

The propolis and the oily part, i.e, aloe vera and propolis glyhcolic extracts, preferably dissolved in ammonium trimethyl cethyl chlorate, of the emulsion formulation eliminates microscopic burrs, which often occur during the blade's manufacture. As mentioned above, the microscopic burrs are responsible for causing cuts and eventual scars on the skin of the user's face or body. The burrs are eliminated by the homogenization of the blade. When the blade is submerged in the emulsion of the invention, the microscopic burrs are eliminated due to the martensitic property of the blade material. The emulsion excites the molecular regeneration of the blade causing the homogenization. Another advantage of the emulsion is avoiding nailed hair during shaving due to homogenization sharpening the blade.

As the hair is removed by the keen edge of a sharp shaving blade, a lubricant provided to the blade by the emulsion, penetrates into the pores of the skin, making it smooth and soft. For example, the blade is lubricated by anhydrous lanolin, liquid glycerin, aloe vera glycolic extract, propolis gylcolic extract and propylene glycol, or any combination thereof.

In accordance with one embodiment, the emulsion comprises

| | |
|---|---|
| Soap base | from 5 to 15% |
| Sodium sulfate lauryl ether | from 3 to 7% |
| Cetostearylic alcohol | from 2 to 4% |
| Ammonium trimethyl cethyl chlorate | from 2 to 4% |
| Anhydrous lanolin | from 3 to 7% |
| Liquid glycerin | from 3 to 7% |
| Aloe vera glycolic extract | from 1 to 3% |
| Propolis glycolic extract | from 1 to 3% |
| Propylene glycol | from 0.3 to 0.7% |
| Methyl paraben | from 0.1 to 0.3% |
| Propyl paraben | from 0.1 to 0.3% |
| Hydrolyzed Wheat Oil | from 0.3 to 0.7% |
| Hydrolyzed Soya Oil | from 0.3 to 0.7% |
| Triethanolamine | from 0.5 to 1.5% |
| Fragrance | from 0.3 to 0.7% |
| Color | 0.01% |
| Non-mineralized, deionized water | q.s.p. 100% |

According to another embodiment of the invention, the emulsion comprises:

| | |
|---|---|
| Soap base | from 3 to 7% |
| Sodium sulfate lauryl ether | from 2 to 4% |
| Cetostearylic alcohol | from 1 to 3% |
| Ammonium trimethyl cethyl chlorate | from 1 to 3% |
| Anhydrous lanolin | from 3 to 7% |
| Liquid glycerin | from 3 to 7% |
| Aloe vera glycolic extract | from 1 to 3% |
| Propolis glycolic extract | from 1 to 3% |
| Propylene glycol | from 0.3 to 0.7% |
| Methyl paraben | from 0.1 to 0.3% |
| Propyl paraben | from 0.1 to 0.3% |
| Hydrolyzed Wheat Oil | from 0.15 to 0.35% |
| Hydrolyzed Soya Oil | from 0.15 to 0.35% |
| Triethanolamine | from 0.3 to 0.7% |
| Fragrance | from 0.3 to 0.7% |
| Color | 0.01% |
| Non-mineralized, deionized water | q.s.p. 100% |

In yet another embodiment of the invention, the emulsion comprises:

| | |
|---|---|
| Sodium sulfate lauryl ether | from 15 to 25% |
| Aloe vera glycolic extract | from 1 to 3% |
| Propolis glycolic extract | from 1 to 3% |
| Fragrance | from 0.2 to 0.7% |
| Glycerin | from 3 to 7% |
| Triethanolamine | from 1 to 3% |
| Propylene glycol | from 0.3 to 0.7% |
| Methyl parabene | from 0.1 to 0.3% |
| Propyl parabene | from 0.1 to 0.3% |
| Color | 0.01% |
| Non-mineralized, deionized water | q.s.p. 100% |

In yet another embodiment of the invention, the emulsion comprises:

| | |
|---|---|
| Ammonium trimethyl cethyl chlorate | from 15 to 25% |
| Glycerin | from 3 to 7% |
| Aloe vera glycolic extract | from 1 to 3% |
| Propolis glycolic extract | from 1 to 3% |
| Fragrance | from 0.3 to 0.7% |
| Triethanolamine | from 1 to 3% |
| Propylene glycol | from 0.3 to 0.7% |
| Methyl parabene | from 0.1 to 0.3% |
| Propyl parabene | from 0.1 to 0.3% |
| Color | 0.01% |
| Non-mineralized, deionized water | q.s.p. 100% |

In a preferred embodiment, the emulsion comprises:

| | |
|---|---|
| Soap base | 10% |
| Sodium sulfate lauryl ether | 5% |
| Cetostearylic alcohol | 3% |
| Ammonium trimethyl cethyl chlorate | 3% |
| Anhydrous lanolin | 5% |
| Liquid glycerin | 5% |
| Aloe vera glycolic extract | 2% |
| Propolis glycolic extract | 2% |
| Propylene glycol | 0.5% |
| Methyl parabene | 0.2% |
| Propyl parabene | 0.2% |
| Hydrolyzed Wheat Oil | 0.5% |
| Hyrolyzed Soya Oil | 0.5% |
| Triethanolamine | 1% |
| Fragrance | 0.5% |
| Color | 0.01% |
| Non-mineralized, deionized water | q.s.p. 100% |

In another preferred embodiment, the emulsion comprises

| | |
|---|---|
| Soap base | 5% |
| Sodium sulfate lauryl ether | 3% |
| Cetostearylic alcohol | 2% |
| Ammonium trimethyl cethyl chlorate | 2% |
| Anhydrous lanolin | 5% |
| Liquid glycerin | 5% |
| Aloe vera glycolic extract | 2% |
| Propolis glycolic extract | 2% |
| Propylene glycol | 0.5% |
| Methyl parabene | 0.2% |
| Propyl parabene | 0.2% |
| Hydrolyzed Wheat Oil | 0.25% |
| Hydrolyzed Soya Oil | 0.25% |
| Triethanolamine | 0.5% |
| Fragrance | 0.5% |
| Color | 0.01% |
| Non-mineralized, deionized water | q.s.p. 100% |

In another preferred embodiment, the emulsion comprises:

| | |
|---|---|
| Sodium sulfate lauryl ether | 20% |
| Aloe vera glycolic extract | 2% |
| Propolis glycolic extract | 2% |
| Fragrance | 0.5% |
| Glycerin | 5% |
| Triethanolamine | 2% |
| Propylene glycol | 0.5% |
| Methyl parabene | 0.2% |
| Propyl parabene | 0.2% |
| Color | 0.01% |
| Non-mineralized, deionized water | q.s.p. 100% |

In yet another preferred embodiment, the emulsion comprises

| | |
|---|---|
| Ammonium trimethyl cethyl chlorate | 20% |
| Glycerin | 5% |
| Aloe vera glycolic extract | 2% |
| Propolis glycolic extract | 2% |
| Fragrance | 0.5% |
| Triethanolamine | 2% |
| Propylene glycol | 0.5% |
| Methyl parabene | 0.2% |
| Propyl parabene | 0.2% |
| Color | 0.01% |
| Non-mineralized, deionized water | q.s.p. 100% |

The active components of the emulsion that preserve the blade's edge by preserving the chromium oxides are soap base, e.g., salt of greasy acid of animal tallow saponification, sodium sulfate lauryl ether, cetostearylic alcohol, ammonium trimethyl cethyl chlorate, glycerin, triethanolamine, and lanolin. The remaining components have a cosmetic function and are optional additives.

What is claimed is:

1. An emulsion for preservation of a blade edge during periods of non-use comprising
a blade edge preservation compound of a water-soluble salt of an ether compound or a chlorate compound in an amount sufficient to maintain chromium oxide portions of a blade edge;
a hydrophobic substance in an amount sufficient to reduce water contact with the blade's edge; and
an alcohol in an amount sufficient to assist in solubilizing the hydrophobic substance,
wherein immersion of the blade's edge in the emulsion preserves hardness to facilitate longer service of the blade in shaving.

2. The emulsion of claim 1, wherein the blade edge preservation compound is selected from the group consisting of sodium sulphate lauryl ether, and ammonium trimethyl cethyl chlorate or a combination thereof.

3. The emulsion of claim 1, wherein the hydrophobic substance is selected from the group consisting of: soap base, anhydrous lanolin, and liquid glycerin, or any combination thereof.

4. The emulsion of claim 1, wherein the alcohol is selected from the group consisting of: triethanolamine, and cetostearylic alcohol, or a combination thereof.

5. An emulsion for preserving the cutting edge of a blade, the emulsion comprising: soap base, sodium sulphate lauryl ether, cetostearylic alcohol, ammonium trimethyl cethyl cholorate, anhydrous lanolin, liquid glycerin, and triethanolamine.

6. The emulsion of claim 5, wherein the soap base is present in an amount between about 5-15%, sodium sulphate lauryl ether is present in an amount between about 3 to 7%; the cetostearylic alcohol is present in an amount between about 2 to 4%; the ammonium trimethyl cethyl chlorate is present in an amount between about 2 to 4%; the anhydrous lanolin is present in an amount between about 3 to 7%; the glycerine is present in an amount between about 3 to 7%; triethanolamine is present in an amount between about 0.5 to 1.5, and
wherein the emulsion further comprises an additive selected from the group consisting of: aloe vera glycolic extract; propolis glycolic extract; propylene glycol; methyl parabene; hydrolyzed wheat oil; hydrolyzed soya oil; fragrance; and coloring agent, or any combination thereof.

7. The emulsion of claim 6, wherein the aloe vera glycolic extract is present in a proportion between about 1 to 3%; the propolis glycolic extract is present in a proportion of between about 1 to 3%; the propylene glycol is present in a proportion of between about 0.3 to 0.7%; the methyl parabene is present in a proportion between about 0.1 to 0.3%; the hydrolyzed wheat oil is present in a proportion of between about 0.3 to 0.7%; the hydrolyzed soya oil is present in a proportion of between about 0.3 and 0.7%; the fragrance is present in a proportion of between about 0.3 and 0.7%; the coloring agent is present in a proportion of about 0.01%.

8. The emulsion of claim 6, comprising sodium sulphate lauryl ether, liquid glycerin, triethanolamine, aloe vera glycolic extract; propolis glycolic extract; fragrance; propylene glycol; methyl parabene; coloring agent; and water.

9. The emulsion of claim 8, wherein ammonium trimethyl cethyl chlorate is substituted for the sodium sulphate lauryl ether.

10. The emulsion of claim 8, wherein the glycerin is present in a proportion of about 3 to 7%, the aloe vera glycolic extract is present in a proportion of about 1 to 3%, the propolis glycolic extract is present in a proportion of about 1 to 3%, the fragrance is present in a proportion of about 0.3 to 0.7%, the triethanolamine is present in a proportion of about 1 and 3%, the propylene glycol is present in a proportion of about 0.3 to 0.7%, the methyl parabene is present in a proportion of about 0.1 to 0.3%, the propyl parabene is present in a proportion of about 0.1 to 0.3%, the color is present in aproportion of about 0.01%.

11. The emulsion of claim 8, wherein the sodium sulphate lauryl ether is present in an amount of about 15 to 25%.

12. The emulsion of claim 9, wherein the ammonium trimethyl cethyl chlorate is present in an amount of about 15 to 25%

13. A method for preserving the cutting edge of a blade, the method comprising the steps of:
preparing an emulsion that includes a blade edge preservation compound of a water-soluble salt of an ether compound or a chlorate compound in an amount sufficient to maintain chromium oxide portions of a blade edge, a hydrophobic substance in an amount sufficient to reduce water contact with the blade's edge; and an alcohol in an amount sufficient to assist in solubilizing the hydrophobic substance, and
immersing the blade's edge in the emulsion to preserve its hardness to facilitate longer service of the blade in shaving.

14. The method of claim 13, further comprising mixing and homogenizing the blade edge preservation compound, the hydrophobic substance, and alcohol to form an emulsion; and
allowing the homogenized emulsion to stand for about 24 to 32 hours.

15. The method of claim 13 wherein the blade edge is immersed to lubricate or preserve chromium oxide on the blade edge.

16. The method of claim 13, wherein the blade edge preservation compound is selected from the group consisting of sodium sulphate lauryl ether, and ammonium trimethyl cethyl chlorate or any combination thereof.

17. The method of claim 13, wherein the hydrophobic substance is selected from the group consisting of: soap base, anhydrous lanolin, and liquid glycerin, or any combination thereof.

18. The method of claim 13, wherein the alcohol is selected from the group consisting of: triethanolamine, and cetostearylic alcohol, or a combination thereof.

19. The method of claim 13, wherein the emulsion further comprises a component selected from the group consisting of aloe vera glycolic extract; propolis glycolic extract; propylene glycol; methyl parabene; hydrolyzed wheat oil; hydrolyzed soya oil; fragrance; and coloring agent, or any combination thereof.

20. The method of claim 16, wherein the sodium sulphate lauryl ether is present in an amount between about 3 to 7%, the ammonium trimethyl cethyl chlorate is present in an amount of between about 2-4%, the soap base is present in an amount between about 5 to 15%, the anhydrous lanolin is preent in an amount of between about 3 to 7%, the liquid glycerin is present in an amount of between about 3 to 7%, the triethanolamine is present in an amount of between about 0.5 to 1.5%, and the cetostearylic alcohol is present in an amount of between about 2 to 4%.
